(19) United States
(12) Patent Application Publication
(10) Pub. No.: US 2021/0274383 A1
(43) Pub. Date: Sep. 2, 2021

(54) CONTROLLING APPARATUS, CONTROLLING METHOD, TERMINAL APPARATUS, AND COMMUNICATION METHOD

(71) Applicant: NEC Corporation, Minato-ku, Tokyo (JP)

(72) Inventors: Satoshi KURODA, Tokyo (JP); Toshiyuki TAMURA, Tokyo (JP); Junya OKABE, Tokyo (JP)

(73) Assignee: NEC Corporation, Minato-ku, Tokyo (JP)

(21) Appl. No.: 17/258,323

(22) PCT Filed: Jul. 9, 2019
(86) PCT No.: PCT/JP2019/027085

§ 371 Date: Jan. 6, 2021

(30) Foreign Application Priority Data
Jul. 10, 2018 (JP) 2018-130599

(51) Int. Cl. H04W 28/06; H04L 12/26; H04L 12/723; H04W 28/02

(52) U.S. Cl. CPC H04W 28/06; H04L 43/0864; H04W 28/0284; H04L 45/50; H04L 43/10

(57) ABSTRACT

A control apparatus used in a communicating system, comprising: a first controlling part that controls a data communication from a terminal apparatus via a mobile access line using a mobile network and a non-mobile access line not using the mobile network; a measuring part that performs Ping-measures of the mobile access line and of the non-mobile access line, respectively; a determining part that determines whether the mobile access line or the non-mobile access line is available based on the measuring part; and a second control part that controls a data communication from the terminal apparatus via the access line selected based on the determining part.

### TECHNICAL FIELD

### Description of Related Applications

This application is based upon and claims the benefit of the priority of a Japanese patent application No. 2018-130599 filed on Jul. 10, 2018, the disclosure of which is incorporated herein in its entirely by reference thereto.
The present invention relates to a controlling apparatus, a controlling method, a terminal apparatus and a communicating method.

### BACKGROUND

There may be two or more lines of Internet access paths from a base in a network where SD-WAN (Software Defined Wide Area network) is applied. For example, Internet Access may be performed from the base in a network where SD-WAN is applied by means of dedicated lines using MPLS (Multi-Protocol Label Switching) or mobile lines using LTE (Long Term Evolution), etc.

In such network, a line to be used (dedicated line, mobile line) is selected based on information called as IP (Internet Protocol)-5tuple (transmission source address etc.), Application type (DPI: Deep Packet Inspection) or the like.

Non Patent Literature 1 is a specification of an open-flow switch used in constructing a SDN (Software Defined Network). Patent Literature 1 discloses a technique for determining a line to be used among a plurality of lines by referring to past one session of network information (RTT: Round Trip Time et al.).

### CITATION LIST

### Patent Literature

### [Patent Literature (PTL) 1]

Japanese Patent Kokai Publication No. JP 2010-187039A

### Non Patent Literature

### [Non Patent Literature (NPL) 1]

OpenFlow Switch Specification Version 1.5.1 (Protocol version 0x06), ONF, [online], [retrieved Jun. 26, 2018], Internet <URL: haps ://3vf60mmveq1g8vzn48q2o71a-wpengine. netdna-ssl.com/wp-cont ent/uploads/2014/10/openflow-switch-v1.5.1.pdf>

### SUMMARY

### Technical Problem

Each of the disclosures in the above CITATION LIST shall be incorporated in this document by reference. The following analysis is given by the present invention.

As described above, in a network where SD-WAN is applied, when there are two or more lines of Internet Access paths (MPLS line, Mobile line, et al.) there is an occasion where a line to be used is selected according to a destination of communication or an application type etc. But in every base (for example, branch of a corporation), the selection of line to be used could not be performed under consideration of vacant bandwidth of Internet Access lines of carrier data center side and/or MPLS line in each branch of corporation.

Many MPLS lines have a contract type of “guaranteed bandwidth, no limitation on traffic”, while many mobile lines have a contract of “best-effort type, limited on traffic”. When companies and others have such a contract, they will use the mobile line as an alternative line when the MPLS line becomes congested. However, because the criteria for line switching are unclear, there is a current situation that they cannot make an effective use of the contracted bandwidth of an expensive MPLS line, which is of high quality and has no traffic limit, upto the upper limit.

In the technology disclosed in the PTL1, a line to be used is selected with reference to past one session of network information. However, since the actual network state changes with time, the selection of a line based on the past one session of network information may not always result in an optimal line selection. For example, even if a line is selected from a plurality of lines by referring to the vacant bandwidth of the line, there may be fluctuations or bursts (instantaneous increase in communication traffic) in the network. Therefore, if the line is selected without considering these phenomena (fluctuations and bursts) that may occur in the network, the selection of the most appropriate line may not be possible.

It is a principal object of present invention to provide a controlling apparatus, a controlling method, terminal apparatus, and a communication method that contribute to select a most optimum line from a plurality of lines.

### Solution to Problem

According to a first aspect of the present invention or disclosure, there is provided a control apparatus used in a communicating system, comprising: a first controlling means that controls a data communication from a terminal apparatus via a mobile access line using a mobile network and a non-mobile access line not using the mobile network; a measuring means that performs Ping-measuring of the mobile access line and of the non-mobile access line, respectively; a determining means that determines whether the mobile access line or the non-mobile access line is available based on the measuring means; and a second control means that controls a data communication from the terminal apparatus via the access line selected based on the determining means.

According to a second aspect of the present invention or disclosure, there is provided a control method for control apparatus used in a communicating system, comprising: controlling a data communication from a terminal apparatus to a server in the communicating system via a mobile access line using a mobile network and a non-mobile access line not using a mobile network; performing Ping-measure for the mobile access line and the non-mobile access line, respectively; determining based on the result of the Ping-measuring whether the mobile access line or the non-mobile access line is available; and controlling a data communication from the terminal apparatus via the access line selected by the determining.

According to a third aspect of the present invention or disclosure, there is provided a terminal apparatus used in a communicating system, comprising: a first communicating means that performs a data communication with a server in the communicating system via a mobile access line using a mobile network and a non-mobile access line not using the mobile network; and a second communicating means that performs Ping-measure for the mobile access line and the non-mobile access line, respectively; and performs data communication with the server via the mobile access line when the mobile access line is determined as more useful than the non-mobile access line.

According to a fourth aspect of the present invention or disclosure, there is provided a communicating method for terminal apparatus used in a communicating system, comprising: performing data communication with a server in the communicating system via a mobile access line using a mobile network and a non-mobile access line that does not use the mobile network; performing Ping-measure for the mobile access line and the non-mobile access line, respectively; and performs data communication with the server by using the mobile access line when the mobile access line is determined as more useful than the non-mobile access line.

### Advantageous Effects of Invention

According to the present invention, it is possible to provide a controlling apparatus, a controlling method, terminal, and a communicating method that contribute to selecting a most optimum line from a plurality of lines.

### BRIEF DESCRIPTION OF THE DRAWINGS

FIG. 1 is a block diagram showing an outline of an exemplary embodiment of the present invention.

FIG. 2 is a diagram showing an example of schematic configuration of a communicating system of a first exemplary embodiment.

FIG. 3 is a diagram showing an example of processing configuration (processing module) of a controller of the first exemplary embodiment.

FIG. 4 is a diagram showing an example of a processing configuration (processing module) of a gateway of the first exemplary embodiment.

FIG. 5 is a sequence diagram showing an example of operation of a communicating system of the first exemplary embodiment.

FIG. 6 is a diagram showing an operation of a communicating system of the first exemplary embodiment.

FIG. 7 is a diagram showing an operation of a communicating system of a second exemplary embodiment.

FIG. 8 is a diagram showing an example of variation of a communicating system of a third exemplary embodiment.

FIG. 9 is a diagram showing an operation of a communicating system of the third exemplary embodiment.

FIG. 10 is a diagram showing an example of a hardware configuration of a controller.

### DETAILED DESCRIPTION

First, an outline of one exemplary embodiment of this invention will be described with reference to the drawings. Reference numbers affixed to each element in this outline are provided for convenience as an example for facilitating understanding, and not intended to limit the present invention to the illustrated modes. And each connection line between blocks in the referenced drawings appearing in the following description includes both bi-directional and mono-directional. A mono-directional arrow describes main data flow schematically, which, however, does not exclude bi-directionality. There are I/O ports, respectively in each joint point of block diagram in the figures, while not illustrated in the figures. The same applies to input/output interfaces.

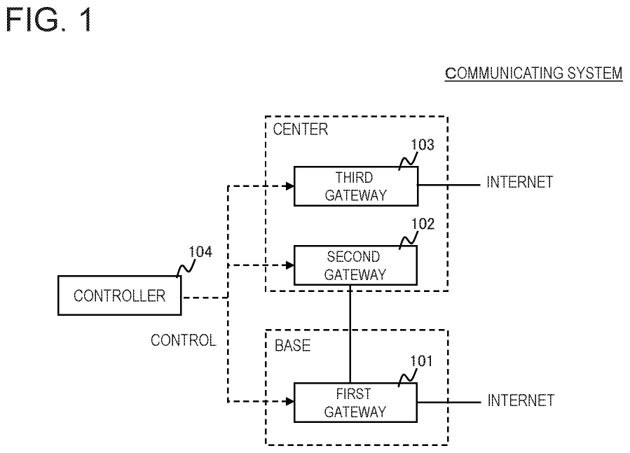

The communicating system according to one exemplary embodiment comprises a first gateway 101, a second gateway 102, a third gateway 103, and a controlling part 104 (see FIG. 1). The first gateway 101 is a gateway installed at a base that includes a terminal and is connected to at least a first line and a second line. The second gateway 102 is connected to the first gateway 101 through the first line. A third gateway 103 is located in the same center as the second gateway 102 and is connected to a third line for connecting to the Internet. The controller 104 controls the first gateway 101, the second gateway 102, and the third gateway 103. The controller 104 calculates an indicator indicating the status of at least one of the first, second, and third lines, and controls the line switching at the first gateway 101 based on a result of statistical processing on the calculated indicator.

The above communicating system calculates an indicator (e.g., a line congestion rate) indicating a condition of a line for accessing the Internet from a base, and performs statistical processing (e.g., calculating a median value) on said calculated indicator. Since the result obtained by said statistical processing is a value that accurately reflects the line status of the network, the controller 104 controls the switching of the line based on the result of said statistical processing, thereby avoiding the selection of an inappropriate line.

A more detail of a specific exemplary embodiment will be described with reference to the drawings below. In each exemplary embodiment, the same configurating elements are identified with the same sign and the description thereof is omitted.

### First Exemplary Embodiment

A more detail of a first exemplary embodiment will be described with reference to the drawings.

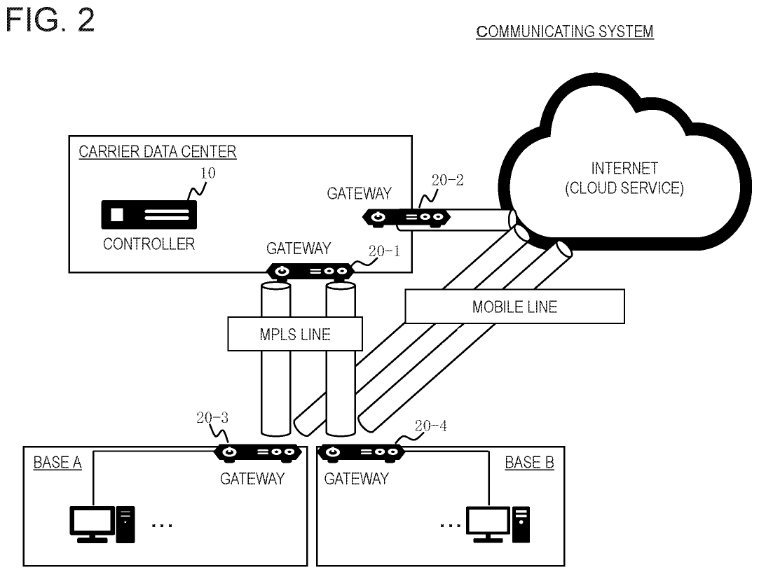

FIG. 2 is a diagram showing an example of schematic configuration of a communicating system of the first exemplary embodiment. Referring to FIG. 2, the communicating system includes a carrier data center and bases A and B.

A carrier data center includes controller 10, gateways 20-1 and 20-2. The carrier data center is a site that is operated and managed by an MPLS line provider.

Bases A and B are branches of a company and other kind of thereof that use MPLS lines provided by the carrier data center. Each branch includes a plurality of terminals. Terminals of each base access server et al. on the Internet.

For the purpose of this application, it is assumed that an MPLS line is a line that provides high quality communication due to a difference in transmission media (physical line type such as optical fiber and radio waves) and an SLA (Service Level Agreement) contract.

The gateway 20-1 is a gateway that is connected to a gateway 20-3 through an MPLS line (a first line). The gateway 20-1 terminates the MPLS line. The gateway 20-2 is located in the same center (carrier data center) as the gateway 20-1 and is connected to a line for connecting to the Internet (a third line). The gateway 20-2 is a communication device that connects the carrier data center to the Internet. The gateways 20-1 and 20-2 are connected by wired or wireless communication and are configured to enable data (packets) to be exchanged with each other.

The gateway 20-3 is installed at Base A. Similarly, a gateway 20-4 is installed at Base B. The gateway 20-3 and the gateway 20-4 are installed at the base including terminals. Gateways 20-3 and 20-4 are gateways installed at the bases including the terminals, and are gateways connected to at least the MPLS line (first line) and the mobile line (second line).

In the following description, when there is no special reason to distinguish gateways 20-1 to 20-4, they are simply referred to as “gateway 20”. The gateway 20 is an SD-WAN gateway (SD-WAN router) that is controlled by a controller 10.

The controller 10 is an SD-WAN controller that controls the gateway 20. The controller 10 calculates an indicator indicating the status of at least one of the MPLS lines, mobile lines, and lines connecting to the Internet, and controls line switching at the gateway 20 at each base based on the results of statistical processing on said calculated indicator.

As shown in FIG. 2, the carrier data center is connected to the Internet through gateway 20-2. Each base is connected to the carrier data center by a virtual dedicated line(s) using MPLS lines. Each base is also configured to be connected to the Internet through a mobile line (mobile network line) such as Long Term Evolution (LTE).

Thus, in the communicating system of the first exemplary embodiment, there are two Internet access routes from bases A and B: an MPLS line (MPLS network) through a carrier data center and a mobile line (mobile network).

The configuration of FIG. 2 is, of course, an example and is not intended to limit the configuration of the communicating system. For example, in FIG. 2, there is one Internet access line from the carrier data center, but there may be more than one of such line. Also, although two bases A and B are illustrated in FIG. 2, it is of course not intended to limit the number of bases.

The controller 10 and the gateway 20 are connected by a dedicated control line (not shown) and are configured to enable the transmitting/receiving of control information and the like. The controller 10 is, for example, an open flow controller, and the gateway 20 is, for example, an open flow switch. These basic operations are described in the NPL1 and are therefore omitted from this description.

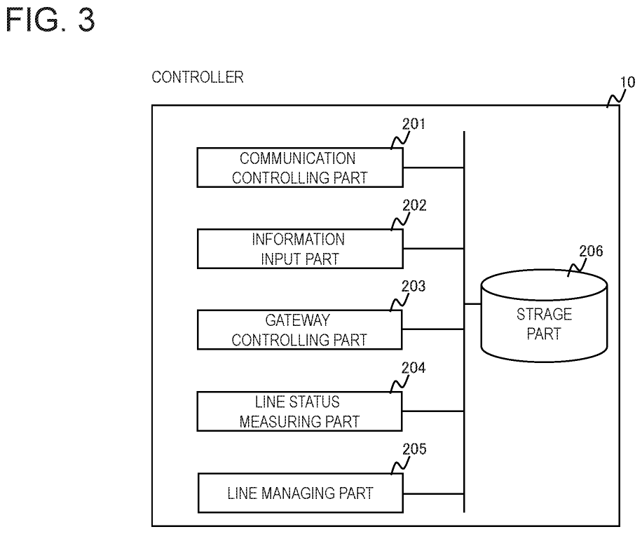

FIG. 3 shows an example of a processing configuration (processing module) of the controller 10. Referring to FIG. 3, the controller 10 comprises a communication control part 201, an information input part 202, a gateway controlling part 203, a line status measuring part 204, a line management part 205, and a storage part 206.

The communication controlling part 201 is a means configured to control communication with the gateway 20. The communication controlling part 201 transmits a packet obtained from another processing module (e.g., the gateway controlling part 203, etc.) to the gateway 20. The communication control part 201 also allocates the packets obtained from the gateway 20 to the other processing module(s).

The information input part 202 is a means configured to input information and other information necessary for the operation of the controller 10 from an external source (such as a system administrator or the like). For example, the information input part 202 inputs information about a contract plan for an Internet connection line (a line connecting the gateway 20-2 to the Internet) of the carrier data center. The information about the contract plan includes information about the bandwidth limit of the line concerned.

The information input part 202 also inputs contract plan information regarding the access lines (MPLS lines and mobile lines) at each location. For example, the upper limit of the bandwidth in the MPLS line contract at each site is entered into the controller 10.

The information input part also inputs contract plan information regarding the access lines (MPLS lines and mobile lines) at each location. For example, the upper limit of the bandwidth in the MPLS line contract at each site is entered into the controller 10.

As mentioned above, there are two types of lines for the terminals in each location to access the Internet: MPLS lines and mobile lines.

For example, if a terminal at base A accesses the Internet using MPLS lines, controller 10 sets up a processing rule for each of gateways 20-1 to 20-3 to forward packets sent from base A to the Internet. Among other things, the controller 10 sets up a processing rule for the gateway 20-3 that includes information about identifying information (e.g., source address, destination address, etc.), output ports, etc., to identify the flows that use the MPLS line. The processing rule also includes a process for assigning a label to use the MPLS line.

When a terminal at base A accesses the Internet using a mobile line, the controller 10 sets up a processing rule for the gateway 20-3, including identifying information to identify the flow using the mobile line and information about the output port.

The gateway controlling part 203 sets a processing rule that causes each gateway 20 to periodically send statistical information to the controller 10. For example, the gateway controlling part 203 sets a processing rule for the gateway 20 so that statistical information about the number of packets sent and received per flow (per flow entry) and the number of bytes sent and received is sent to the controller 10. Using the statistical information (traffic information) obtained by the processing rule(s), the controller 10 can calculate the network using bandwidth of the flows accessing the Internet from each location through MPLS lines or mobile lines.

The gateway controlling part 203 preferentially selects an MPLS line as a line to be used when accessing the Internet from each location.

More concretely, the gateway controlling part 203 selects the MPLS line as a destination (to accommodate the flow) for the packets (unknown packets) received by the gateway 20 when the gateway 20 requests to set the processing rule(s).

The processing rule(s) set by the gateway controlling part 203, the obtained statistical information and the like are stored in storage part 206.

A line status measuring part 204 is a means configured to measure a condition of a line connecting the carrier data center to the Internet. Specifically, the line condition measuring part 204 measures the congestion rate of the Internet connection line of the carrier data center. The specific method of measuring the congestion rate is as follows.

Initially, the line status measuring part 204 reads the bandwidth limit from the contract plan information of the Internet connection line of the carrier data center obtained by the information input part 202.

Next, the line status measuring part 204 calculates the currently used bandwidth (transmission rate) from the traffic information (statistical information) obtained from gateway 20-2, which is the gateway for the Internet side exit of the carrier data center.

For example, the line status measuring part 204 calculates the used bandwidth by dividing the number of transfer bytes transmitted from the gateway 20-2 by the transmission interval of the statistical information. Next, the line status measuring part 204 calculates a line congestion rate from the calculated bandwidth used and the bandwidth upper limit read out. Concretely, the line status measuring part 204 calculates the line congestion rate by dividing the calculated bandwidth used by the bandwidth upper limit.

The line status measuring part 204 repeats the above calculation of the line congestion rate for a predetermined number of times (e.g., 10 times) at every predetermined interval (e.g., every second), and performs statistical processing on the plurality of calculated line congestion rates. For example, the line status measuring part 204 calculates the mean, median, and mode of the plurality of line congestion rates and calculates a representative value of the line congestion rate. The line status measuring part 204 passes the calculated representative values of the line congestion rate to a line managing part 205.

The line managing part 205 is a means configured to manage the lines used by the terminals at each base to access the Internet. The line managing part 205 performs threshold processing on the representative value of the line congestion rate obtained from the line status measuring part 204, and determines whether the representative value of the line congestion rate exceeds a predetermined value (threshold).

When the representative value of the line congestion rate is above a predetermined value, the line managing part 205 determines that the line between the carrier data center and the Internet is tight (in congestion). When the line between the carrier data center and the Internet is tight, the line managing part 205 offloads a portion of data (packets) transferred to the Internet through the MPLS line to the mobile line. Concretely, the line managing part 205 generates a processing rule to achieve the above offloading, and sets said generated processing rule to the gateway 20 through the gateway controlling part 203.

As mentioned above, the gateways 20 at each location have a processing rule in which the MPLS lines are used. In other words, during system operation, the controller 10 instructs the gateways 20 at each location to allocate all communications to the MPLS line.

The gateway controlling part 203 also sets up a processing rule that causes the gateway 20 at each base to notify the controller 10 of the fact (packet discard) when it detects packet discard (packet loss) on the MPLS line.

The line managing part 205 determines that the bandwidth used by the MPLS line exceeds the contracted bandwidth limit when packet loss occurs at the gateway 20 at each location. When the line managing part 205 determines that the bandwidth used by the MPLS line exceeds the contracted bandwidth limit, the line managing part 205 offloads a portion of the packets forwarded to the Internet through the MPLS line from each location to the mobile line in a stepwise manner.

For example, the line managing part 205 randomly selects a flow from a plurality of flows that use the MPLS line at each base. The line managing part 205 reads the processing rules (flow entries) corresponding to said selected flows from the storage part 206. The line managing part 205 changes the above-read processing rules to a processing rule such that packets belonging to the selected flow are forwarded through the mobile line. Concretely, the line managing part 205 specifies the flows to be offloaded according to the communication destination ((IP-5tuple) or application type (DPI) unit) and generates a new processing rule with the output destination changed. The generated processing rules are set in each gateway 20 through the gateway controlling part 203 (the flow entries are rewritten).

If the above process (offloading packets of some flows) does not resolve the packet loss on the MPLS line, the line managing part 205 increases the number of flows to be offloaded until the packet loss is resolved. That is, the controller 10 instructs the gateways 20 at each location to switch the destination of the partial data on the MPLS line at each location to a mobile line until the representative value of the line congestion rate between the carrier data center and the Internet falls below a predetermined value (threshold).

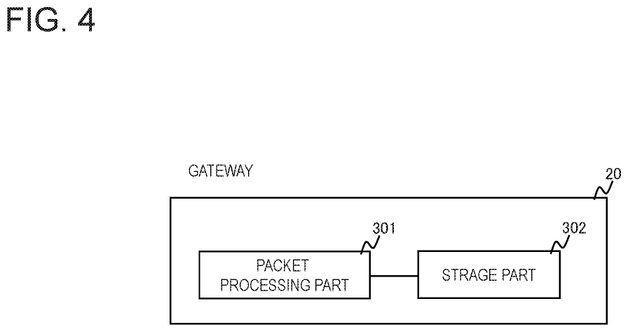

FIG. 4 illustrates an example of a processing configuration (processing module) of the gateway 20. Referring to FIG. 4, the gateway 20 comprises a packet processing part 301 and a storage part 302.

The packet processing part 301 is a means configured to execute a process (packet processing) set by the controller 10. The packet processing part 301 has functions of updating a forwarding table and packet forwarding that the gateway 20 has. For example, when a processing rule (flow entry) is received from the controller 10, it modifies its own forwarding table so that it is forwarded as instructed.

The packet processing part 301 requests the controller 10 to set up a processing rule for processing the received packets (unknown packets) if there are no flow entries compatible with the received packets when they are received.

The packet processing part 301 adds the processing rules sent in response to the request to the forwarding table. Alternatively, when the packet processing part 301 receives a processing rule for offloading packets from the MPLS line to the mobile line, the packet processing part 301 replaces an existing processing rule with a new processing rule (updating the flow table).

The storage part 302 maintains the above transfer table (flow table).

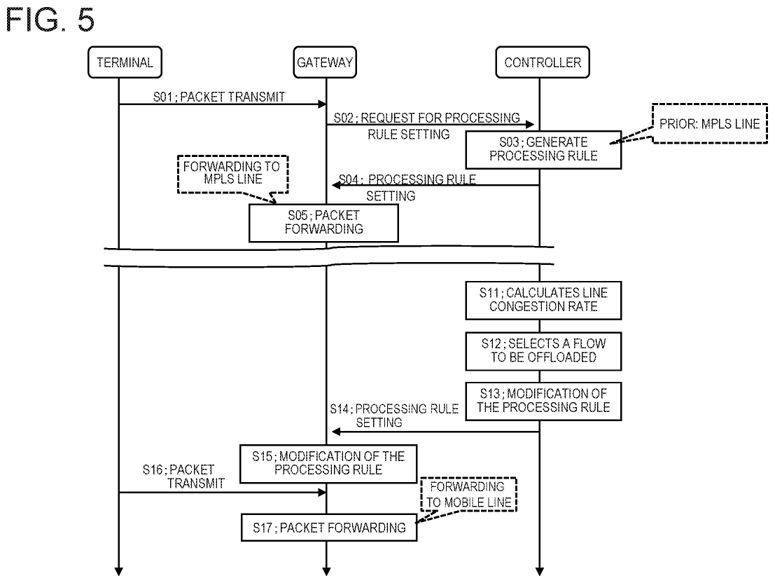

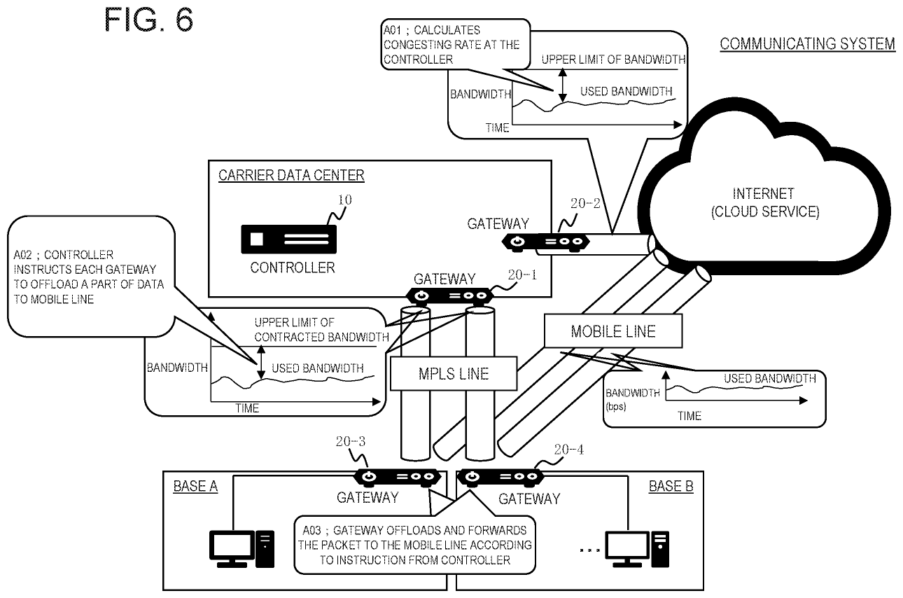

The operation of the communicating system according to the first exemplary embodiment will now be described with reference to the drawings. FIG. 5 is a sequence diagram illustrating an example of operation of the communicating system pertaining to the first exemplary embodiment. FIG. 6 is a diagram illustrating the operation of the communicating system pertaining to the first exemplary embodiment.

First, a terminal at each location transmits packets to a server or other device on the internet (Step S01).

The gateway 20 receives a packet in question, searches the transfer table (flow table) of its own device, and determines whether a processing rule for processing the packet exists or not. If the processing rule does not exist, the gateway 20 makes a request for setting a processing rule to the controller 10 by attaching the packet in question (step S02).

The controller 10 generates a processing rule in response to the request to set the processing rule (step S03). At that time, the controller 10 configures the processing rule so that packets from the terminals at each location are forwarded to the MPLS line.

The controller 10 sets the generated processing rules to the gateway 20 (step S04).

The gateway 20 processes (forwards) packets from the terminal in accordance with the configured processing rule (step 505). The controller 10 generates the processing rule so that the MPLS line(s) is used preferentially, so the packets sent by the terminal are forwarded to the MPLS line(s).

The controller 10 calculates the line congestion rate (a representative value of the line congestion rate) of the lines connecting the carrier data center to the Internet at a periodical or predetermined timing (step S11, step A01 in FIG. 6).

If the controller 10 determines that the above line(s) is tight based on a representative value of the line congestion rate, it offloads a portion of the flows connected to the Internet over the MPLS line(s) to the mobile lines.

Concretely, the controller 10 selects a flow to be offloaded to the mobile line (step S12). Subsequently, the controller 10 generates a new processing rule(s) for offloading the selected flows (step S13; modification of the processing rule(s)).

The controller 10 sets the generated processing rule(s) to the gateways 20 (step S14) and instructs each gateway 20 to offload some flows (step A02 in FIG. 6).

The gateway 20 modifies the existing processing rule(s) (step S15) depending on the received processing rule(s) (processing rule(s) for offloading).

When a terminal at each location sends a packet to a server or the like on the Internet after the change in the said processing rule(s) (step S16), the gateway 20 forwards the packet to the mobile network (step S17, step A03 in FIG. 6).

Thus, the controller 10 calculates a plurality of indicators (a plurality of line congestion rates) in a predetermined period of time in the past, and controls the gateways 20 at each base based on the representative values of the plurality of said calculated indicators. The controller 10 also controls the line switching at the gateway 20 at each base so that packets transmitted from the terminal are forwarded from (via) the mobile line when it is determined that the line connecting the carrier data center to the Internet is tight.

The gateway 20 at each location performs traffic offloading to the mobile line as instructed by the controller 10. For example, if a flow entry corresponding to each of ten flows is set at the gateway 20-3, the controller 10 selects some of the ten flows (e.g., three flows) out of said ten flows. The controller 10 reads the processing rule(s) corresponding to the selected flows from the storing part 206, and changes the output port of the processing rule(s) from an MPLS line to a mobile line. The controller 10 configures a new processing rule(s) (the processing rule(s) for offloading) to the gateway 20-3.

As described above, the first exemplary embodiment performs packet offloading from the MPLS line to the mobile line when the Internet connection is tight and packet loss occurs on the MPLS line. As a result, the user can effectively use the bandwidth available on the MPLS line. In the first exemplary embodiment, an indicator of the network's line status (the line congestion rate) is measured multiple times and statistical processing is performed on the multiple measured values to calculate a value (a representative value of the line congestion rate) that appropriately (accurately) reflects the network's line status.

In the first exemplary embodiment, the selection of a line is based on a value that accurately reflects the state of the network in question, so that an inappropriate line is not selected. For example, in the above example, if the line congestion rate is not statistically processed and a line congestion rate based on a single measurement is used, it may be determined that the line in question be tight when the data transmitted from the carrier data center to the Internet increases instantaneously. In this case, some flows using the MPLS line will be offloaded to the mobile line, resulting in the selection of an inappropriate line (mobile line). However, in practice, if there is no tightness in the above-mentioned line, then the offloading is not necessary and the MPLS line with a greater benefit to the user (high quality and flat fee) is still selected as the correct line.

In the first exemplary embodiment, the effect of “fluctuations” or “bursts” caused in the network concerned is eliminated by calculating an indicator indicating the state of the network several times and calculating its representative value. As a result, the optimal line can be selected from multiple lines. More concretely, let us assume that there are multiple Internet access routes (e.g., MPLS lines, mobile lines, etc.) from the base in a network to which SD-WAN is applied, as shown in FIG. 2. In this case, in the first exemplary embodiment, the contracted bandwidth of the high-quality MPLS line can be effectively utilized up to the upper limit by rerouting it to an alternative route taking into account the congestion rate of the Internet access line from the carrier data center.

### Second Exemplary Embodiment

A second exemplary embodiment will be described in detail with reference to the drawings.

In the first exemplary embodiment, the packet offloading at each location is performed based on the line status between the carrier data center and the Internet. The second exemplary embodiment describes execution of packet offloading at each location based on the line status between each location and the carrier data center.

The configuration of the communicating system and the processing configuration of each device (controller 10, gateway 20) and the like in the second exemplary embodiment can be the same as in the first exemplary embodiment, so the description thereof will be omitted.

The line status measuring part 204 of the second exemplary embodiment measures the state of the MPLS line connecting each base to the carrier data center. The line status measuring part 204 reads a true bandwidth limit on the MPLS line from a contract plan information of the MPLS line for each location.

Next, the line status measuring part 204 sets the bandwidth limit for measuring the state of the MPLS network based on the read bandwidth limit. For example, the line status measuring part 204 sets the bandwidth limit of the MPLS line to about 80% of the true bandwidth limit of the MPLS network. Alternatively, the line status measuring part 204 may determine the above upper limit from the actual bandwidth usage and other factors. The line status measuring part 204 determines the bandwidth limit of the MPLS line with some margin, taking into account the fluctuations and/or bursts of the MPLS line.

Next, the line state measurement unit 204 calculates the used bandwidth of the MPLS line. Specifically, the measurement unit 204 calculates the bandwidth of each flow based on the statistics (traffic information) of each flow accessing the Internet from each base (per flow entry). A total bandwidth of each flow is a bandwidth used by the MPLS line connecting the base and the carrier data center.

Next, the line status measuring part 204 calculates the free(vacant) bandwidth by subtracting the bandwidth used by the MPLS line from the bandwidth limit of the MPLS line at each location. The line status measuring part 204 calculates the free band (range) of the MPLS line based on the bandwidth limit obtained from the contract plan information of the MPLS line and the used band (range) of the MPLS line (the used bandwidth calculated from the traffic information obtained from the gateway 20).

The line status measuring part 204 repeats the above calculation of the free bandwidth for a predetermined number of times at a predetermined interval, and performs statistical processing on the plurality of calculated free bandwidth. For example, the line status measuring part 204 calculates a mean, median, and mode of the plurality of free bandwidth and calculates a representative value of the free bandwidth. The line status measuring part 204 passes the calculated representative values of the free bandwidth to the line managing part 205.

The line managing part 205 determines that the MPLS line is tight because a negative representative value of the free bandwidth means that the bandwidth used on the MPLS line is greater than the bandwidth limit with a margin. On the other hand, if the representative value of the free bandwidth is positive or zero, it means that the bandwidth used on the MPLS line is less than the bandwidth limit with a margin, and therefore, it does not consider that the MPLS line is tight.

When the line managing part 205 determines that the MPLS line is tight, it controls the line at each location so that the tightness is resolved. The line managing part 205 generates a processing rules for offloading packets from the MPLS line to the mobile line at each site. The generated processing rule(s) is set to the gateway 20 through the gateway controlling part 203.

Concretely, the line managing part 205 selects a flow that consumes a more bandwidth than the using bandwidth that exceeds the bandwidth limit of the MPLS line based on statistical information (traffic information) obtained from the gateways 20 at each location. Alternatively, the line managing part 205 selects a plurality of flows in which the sum of the used bandwidth in the plurality of flows is greater than the used bandwidth that exceed the bandwidth limit of the above MPLS line.

The line managing part 205 generates a processing rule such that packets belonging to the selected flow are offloaded from the MPLS line to the mobile line (the processing rule is changed).

The line managing part 205 may calculate the used bandwidth of each flow from the traffic information of the gateway 20, identify the flows so that the sum of such used bandwidth fits within the bandwidth limit of the MPLS line, and generate processing rules so that flows other than the identified flows are offloaded. The line managing part 205 instructs the gateway 20 to select the amount of data (in units of communication destination (IP-5tuple) or application type (DPI)) that fits into the free bandwidth from the traffic information of the gateway 20 and allocate it to the MPLS line side. In this case, the amount of data that does not fit on the MPLS line is offloaded to the mobile line (the controller 10 instructs the gateway 20 to offload the data to the gateway 20).

Whether or not the offloading can be executed by the line managing part 205 may be determined by referring to past traffic information and OS (operating system) vendor OS update information. For example, the line managing part 205 may predict traffic in the near future by referring to historical data such as daily traffic distribution throughout the year and traffic distribution in units of minutes throughout a particular day, as well as a wide variety of external data (big data) to determine whether to allocate the traffic to the mobile line. For example, the line managing part 205 may refer to past traffic information to predict when large sized data due to an OS update will be sent and received, and the data of the OS update may be sent and received over the MPLS line. The prediction of traffic in the near future may be carried out using Artificial Intelligence (AI).

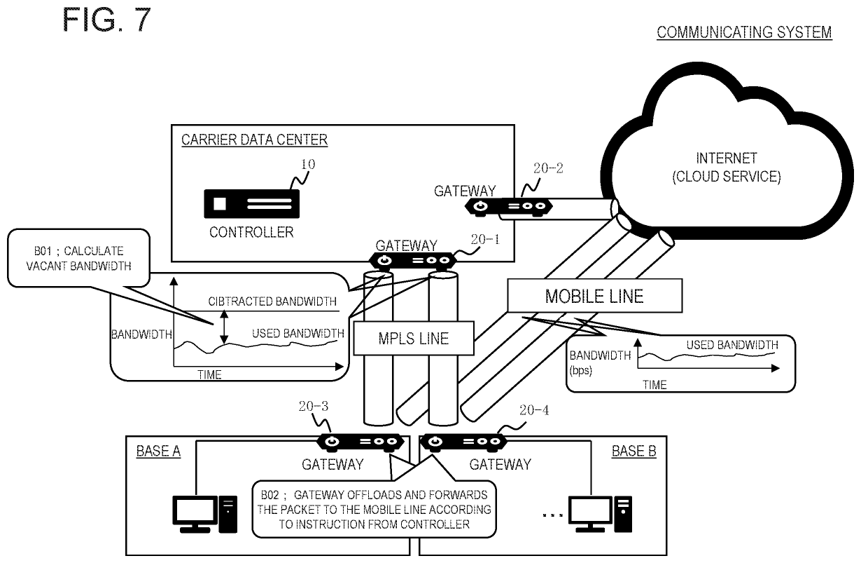

The operation of the communicating system according to the second exemplary embodiment will now be described with reference to the drawings. FIG. 7 is a diagram illustrating the operation of the communicating system in the second exemplary embodiment.

As shown in FIG. 7, the controller 10 calculates the free bandwidth (unused bandwidth) of the MPLS line (step B01). If the controller 10 determines that the MPLS line is tight based on the estimated free bandwidth, the controller 10 offloads a portion of the flows using the MPLS line to the mobile line (step B02).

Thus, the controller 10 controls line switching at the gateway 20 at each location so that packets sent from the terminals at each location are forwarded from(via) the mobile line when it is determined that the MPLS line is tight.

### [Variant Example of Second Exemplary Embodiment]

In the above description, the controller 10 calculates the free bandwidth statically (Proactive/Static) from the traffic information obtained from the gateway 20; however, the controller 10 may also calculate the free bandwidth by other methods. Concretely, the controller 10 may measure the free bandwidth on the MPLS line dynamically (proactive/dynamic) and use it as a reference for packet offloading.

First, the gateway controlling part 203 generates a processing rule for sending and receiving data for testing with a minimum priority (e.g., an IP Precedence value of “0”) between the gateways 20 of the carrier data center and the gateways 20 of each location, and sets the rule to each gateway. The gateway controlling part 203 also sets a processing rule that causes each gateway 20 to notify the controller 10 when data for testing is received.

Further, when the gateway control unit 203 obtains the above notification (notification of receipt of data for testing) from the gateway 20, the gateway control unit 203 sets a processing rule that causes the gateway 20 to send and receive data for testing that is larger in size between the gateways 20. When the gateway controlling part 203 does not receive the above notification (notification of receipt of data for testing) from the gateway 20 after a predetermined period of time, the gateway controlling part 203 notifies the line status measuring part 204 of this fact. At the same time, the gateway controlling part 203 notifies the line status measuring part 204 of also the data size of the last received test data when the notification of reception of the data for the test cannot be received.

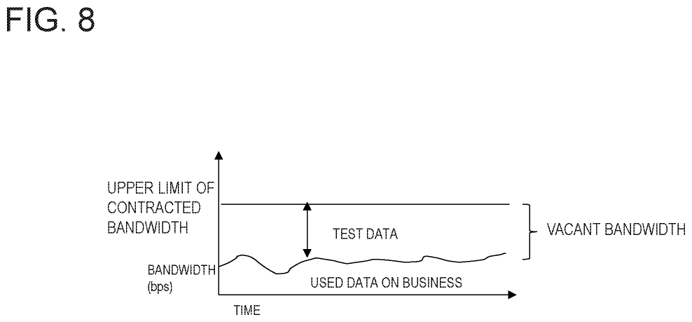

Here, the data exceeding the contracted bandwidth limit of the MPLS line is discarded in the MPLS line. The line status measuring part 204 takes advantage of this fact and measures the free bandwidth of the MPLS line based on the information obtained from the transmission and reception of the test data. As mentioned above, the test data is transferred at the lowest priority, so data that exceeds the upper limit and is discarded by the gateway in the MPLS line becomes test data (see FIG. 8). In other words, the bandwidth used by the test data that is not discarded corresponds to the bandwidth not used by the normal data (data for business use). In other words, the communication bandwidth of the undiscarded test data corresponds to a free bandwidth of the MPLS line.

The measuring part 204 calculates the used bandwidth of the test data based on the transmission and reception time of the acquired test data and the packet size, and calculates the free bandwidth. The communication status measuring part 204 repeats the above calculation of the free bandwidth and performs statistical processing on a plurality of the obtained free bandwidth to calculate a representative value.

The line managing part 205 sets (changes) the processing rule(s) to accommodate the amount of data that fits within the representative value of the free bandwidth on the MPLS line and the amount of data that does not fit on the mobile line, as described earlier.

As described above, the controller 10 pertaining to the second exemplary embodiment determines the amount of data to be switched from the MPLS line to the mobile line based on the upper limit of the bandwidth in the MPLS line contract of each location. More concretely, the controller 10 of the second exemplary embodiment offloads a portion of the flow to the mobile line when the bandwidth used in the MPLS line by each base reaches the bandwidth limit and the packet transmission rate is reduced. As a result, as in the first exemplary embodiment, the bandwidth available to the user on the MPLS line can be used effectively.

### Third Exemplary Embodiment

A third exemplary embodiment will be described in detail with reference to the drawings.

The third exemplary embodiment describes a case in which the state of the mobile line is measured and the line of each base is controlled so as to avoid the total amount limit of the mobile line. The configuration of the communicating system and the processing configuration of each device (controller 10, gateway 20) and the like in the third exemplary embodiment can be the same as in the first exemplary embodiment, so that the description thereof is omitted.

Normally, when the total amount of traffic is limited, the communication speed is limited to a low speed (e.g., 128 kbps). Under such circumstances, the normal use of the mobile line becomes difficult due to disruption of business at each location. In the third exemplary embodiment, in order to avoid such a situation, the following controls are implemented to prevent the total amount of communication traffic from being limited on the mobile line side.

The line status measuring part 204 in the third exemplary embodiment analyzes trends in data use amount(volume) for each mobile line based on statistical information (traffic information) obtained from the gateways 20 at each location.

The line managing part 205 of the third exemplary embodiment determines whether or not the total volume limit of the mobile line is expected to be applied to suppress the communication speed. Concretely, the line managing part 205 calculates the ratio of the amount of data used to the amount of data used (using rate) by referring to the amount of data used of the mobile line and the contractually allowed amount of data of the mobile line. The line managing part 205 performs threshold processing on the said using rate, and determines that the total amount limit may be applied when the using rate exceeds a certain value. For example, consider a case in which the allowable data is set on a monthly basis in a mobile line contract. In this case, the number of days that have passed since the beginning of the month is managed by mapping the number of days that have passed since the beginning of the month to the using rate at which the total volume limit is expected to be applied. For example, if the using rate exceeds 50% before half of the month has elapsed, the line managing part 205 determines that the total volume limit will be applied in the current month. In contrast, if the using rate is still below 50% after half of the month has passed, the line managing part 205 determines that the total volume limit is not applied in the month.

When it is determined that the total volume limit of the mobile line is applicable, the line managing part 205 takes the following actions.

For example, the line managing part 205 purchases an additional amount of data to extend the limit of the total volume limit from the carrier providing the mobile communication. Concretely, the line managing part 205 notifies the manager and others of an alert that prompts them to purchase an additional amount of data (purchase of a frame) in order to extend the limit of the total volume limit. For example, the line managing part 205 executes the above alert using a pop-up notification of the above content on a maintenance management screen of the controller 10, sending an email, or the like.

Thus, the controller 10 calculates the total amount of data transmitted from the terminal to the Internet through the mobile line, and determines whether or not a total volume limit on the mobile line is applied to suppress the communication speed based on the calculated total amount of data. If it is even determined that the total volume limit is applied, the controller 10 performs a process to increase the contractual limit of allowable data on the mobile line.

Alternatively, the line managing part 205 may drop packets for non-priority applications (other than business applications) that are communicating, on the mobile line side. Concretely, the line managing part 205 sets a processing rule in the gateway 20 at each location such that the packets pertaining to the above non-priority applications are dropped. In other words, the line managing part 205 generates a processing rule such that packets used by applications that do not permit the use of the mobile line (non-priority applications; applications that are not used for business) are discarded at the gateway 20 of each base.

Alternatively, the line managing part 205 may discard packets at a predetermined rate so that the total volume limit is not applied until the end of the month when the data usage of the mobile line is reset (initialized), based on the results of the trend analysis of data usage for each mobile line described above.

For example, assuming that you have a contract that restricts your communication speed to 128 kbps once you exceed 7GB per month, and your data usage by April 10th is 3GB. According to this analysis, the average daily communication data volume is found to be 0.3GB. Therefore, it is expected that the total volume limit will be applied (the amount of communication data will not reach 7GB) on April 24. If the current date is April 10, then there are 20 days left until the end of the month, which means that the amount of communication data that can be used during this period is 4GB. Therefore, in order to prevent the total amount of data from being applied before the end of the month, the average amount of data per day must be limited to 0.2GB (=4GB/20 days).

Therefore, the line managing part 205 generates a processing rule to discard packets using the mobile line so that the average amount of communication data per day at the present time is limited to 0.2 GB per day. In this case, since it is necessary to limit the data usage of 0.3 GB per day to 0.2 GB per day, the line managing part 205 sets a processing rule for discarding packets at a rate of 33 (=0.2/0.3) % to the gateway 20.

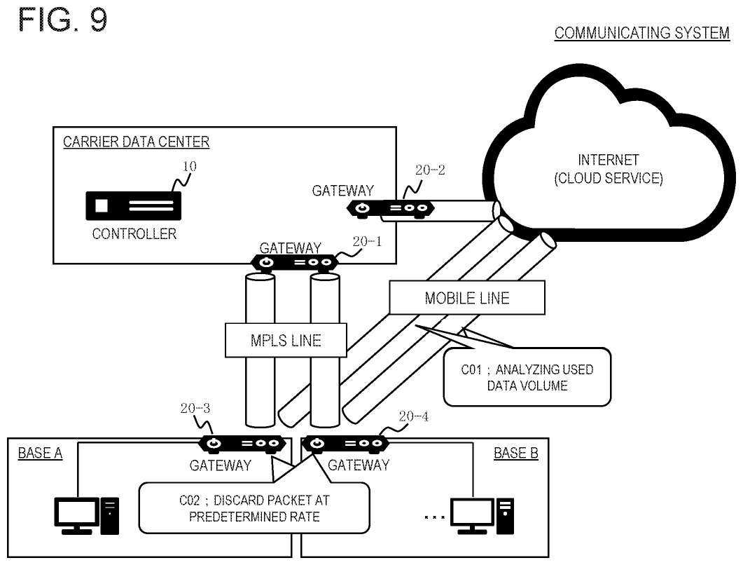

The operation of packet discarding at the above predetermined rate is summarized in FIG. 9. First, controller 10 performs an analysis of the data usage per mobile line (step C01). Based on the results of the analysis, controller 10 determines whether the total volume limit will be applied if the mobile line is used at the current pace.

If it is determined that the total volume limit applies, the controller 10 discards the packets transmitted to the Internet over the mobile line at a specified rate (step C02).

As described above, the third exemplary embodiment measures the state of the mobile line and controls the packet processing on the mobile line based on the results of the measurement. As a result, the total volume limit on the mobile line is not applied, and the operations at each location can be carried out smoothly.

### [Hardware Configuration]

A hardware configuration of each of apparatus configuring a network system will be described.

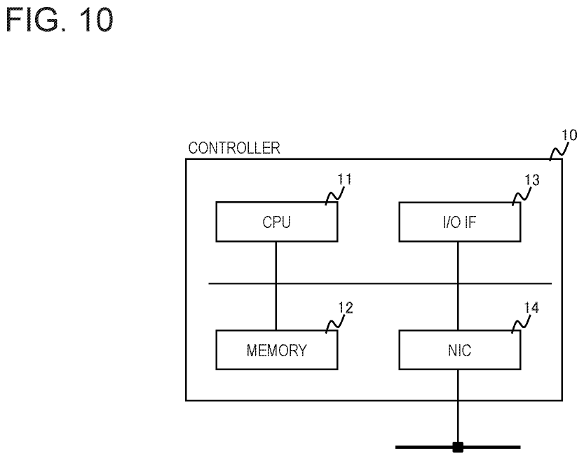

FIG. 10 shows an example of a hardware configuration of the controller 10. The controller 10 has the configuration shown in FIG. 10.

For example, the controller 10 has a CPU (Central Processing Unit) 11, a memory 12, an input/output interface 13, an I/O interface 13, a NIC (Network Interface Card) 14, etc., which are interconnected by an internal bus, and the like. The configuration shown in FIG. 10 is not intended to limit the hardware configuration of the controller 10. The controller 10 can also include hardware not shown in the figure.

The memory 12 is RAM (Random Access Memory), ROM (Read Only Memory), HDD (Hard Disk Drive), etc.

The I/O interface 13 is a means configured to interface an I/O device not shown in the figure. The I/O device includes, for example, a display device, an operation device, and the like. The display device is, for example, a liquid crystal display or the like. The operation device is, for example, a keyboard, a mouse, and the like.

Each processing modules of the above-described controller 10 is implemented, for example, by the CPU 11 executing a program stored in the memory 12. The program can be downloaded over a network or updated by using a storage medium storing the program. Further, the above processing module can be realized by a semiconductor chip. That is, there may be means configured to execute the functions performed by the above processing modules in any hardware and/or software.

Since the gateway 20 can have the same hardware configuration as the controller 10, the description is omitted.

### [Variations]

The communicating system described in the first and third exemplary embodiments above is only an example and is not intended to limit the configuration of the system or otherwise. For example, the above exemplary embodiments do not take into account the contents of the flows (contents of the packets) that are offloaded to the mobile line. In other words, when the communication data (in units of destination (IP-5tuple) or application type (DPI)) is allocated to each line, in the above exemplary embodiment, the line is switched without consideration of the contents of the communication data.

In addition to these responses, the controller 10 may control line switching at the gateway 20 at each location based on information described in a payload of the packet. In other words, the controller 10 may select a flow to be offloaded based on the content of the communication data. Concretely, with respect to selection of the communication data (flows) to be load-balanced, the following actions may be taken.

First, the controller 10 may switch-over lines under consideration of “session” or “protocol” of a flow connecting to the Internet over the MPLS line. For example, with respect to HTTP (Hypertext Transfer Protocol), QUIC (Quick UDP Internet Connections), SIP (Session Initiation Protocol), etc., it is possible to maintain a session at an upper layer.

Therefore, the controller 10 offloads with priority to the mobile line with respect to flows that contain packets (communication data) pertaining to such protocols. In contrast, with respect to FTP (File Transfer Protocol), TELNET (Telnet), SSH (Secure Shell), and the like, the session is disconnected due to line switching. Therefore, the controller 10 refrains from line switching (i.e., offloading to the mobile line) as much as possible for flows that accommodate packets related to these protocols.

For services that can be provided at a guaranteed minimum transmission rate (Guaranteed Bit Rate), such as voice communications and video (TV) telephony, MPLS lines should be used with priority.

Thus, the controller 10 may control line switching at the gateway 20 at each location based on the type of application that uses the packets sent to the Internet from the terminals at each location.

Secondly, the controller 10 may switch lines with awareness of the session, the protocol, and the communication time length of the session. For example, a session with a short communication time length at one time is unlikely to have a conflict between the timing during a session connection and the line switching timing. Therefore, the controller 10 preferentially offloads flows that accommodate packets pertaining to sessions and protocols with short session durations to the mobile line.

In the above exemplary embodiment, offloading is achieved by specifying flows from the controller 10 to the gateways 20 at each location, but the gateways 20 at each location may also determine the flows to be offloaded. In this case, the controller 10 informs the gateway 20 of the upper limit of the MPLS line. The gateway 20 may offload some flows to the mobile line if it determines that the said limit be exceeded.

The instruction to switch to the mobile line may include traffic information to be switched. For example, by including a service server (e.g., the cloud service server shown in FIG. 2 or the like) as the traffic information, the gateway 20 of each branch office can switch to the mobile line only for a specific traffic.

In the above exemplary embodiment, the scheme for offloading flows from the MPLS line to the mobile line is described, but the above described scheme may be used alone or in combination with multiple offloading schemes. In addition, Ping measurements may be performed from the gateway 20 at each location to the destination server through the MPLS line and the mobile line, respectively, and the line may be switched-over according to the results of the measurements. For example, if the Ping measurement results show that the round trip time (RTT) of the mobile line is of a higher quality (RTT is shorter) than the MPLS line, a decision may be made to offload to the mobile line.

In addition, the following information may be used to instruct the gateway 20 to make a line switching decision:

In a case where it is determined that the Internet connection line is disconnected.
In a case where information indicating congestion is set in packets coming from a service server (e.g., a cloud service server).
Note, the Explicit Congestion Notification (ECN) specified in RFC 3168 can be used as information to indicate congestion.

Though the industrial applicability of the present invention is evident according to the above description, the present invention can be suitably applied to dedicated line services (e.g., MPLS, IP-VPN; IP Virtual Private Network, etc.).

Some or all of the above exemplary embodiments may also be described as described in the appendix below, but not limited to the following.

### [Mode 1]

A communicating system comprising:

a first gateway that is installed at a base containing a terminal, being connected to at least a first line and a second line,
a second gateway that is connected to the first gateway through the first line,
a third gateway that is installed in the same center as the second gateway and being connected to a third line for connecting to the Internet, and
a controller that controls the first, the second, and the third gateways; wherein the controller calculates an index that indicates a status of at least one of the first, second and third lines, and controls line switching at the first gateway based on the results of statistical processing of calculated index.

### [Mode 2]

The communicating system, preferably as described in Mode 1, wherein the controller calculates a plurality of the indices in a past predetermined period of time, and control line switching at the first gateway based on representative values of the plurality of calculated indices.

### [Mode 3]

The communicating system, preferably as described in Mode 1 or 2, wherein the controller controls line switching at the first gateway to transfer part of packet determined the line switching at the first gateway is controlled so that a portion of the packets sent from the terminal are forwarded from the second line when it is determined that the first line is tight.

### [Mode 4]

The communicating system, preferably as described in Mode 1 or 2, wherein the controller controls line switching at the first gateway so that some of the packets sent from a terminal are forwarded from(via) the second line when it is determined that the third line is tight.

### [Mode 5]

The communicating system, preferably as described in any one of Modes 1 to 4, wherein the controller controls line switching at the first gateway based on information described in a payload of the packets sent from the terminal to the Internet.

### [Mode 6]

The communicating system, preferably as described in Mode 5, wherein the controller controls line switching at the first gateway based on the type of application using the packets sent from the terminal to the Internet.

### [Mode 7]

The communicating system, preferably as described in any one of Modes 1 to 6, wherein the second line is a mobile line, and the controller calculates the total amount of data transmitted from the terminal to the Internet through the second line, and performs a process to increase the contractual limit of allowable data on the second line if it is expected that the total volume limitation on the second line will be applied and a communication speed will be suppressed.

### [Mode 8]

The communicating system, preferably as described in Mode 7, wherein the controller controls the first gateway to discard packets transmitted from the first gateway through the second line at a predetermined rate if it is predicted that the total volume limitation on the second line will be applied.

### [Mode 9]

The communicating system, preferably as described in Mode 8, wherein the controller controls the first gateway to discard packets used by an application that does not allow the second line to be used.

### [Mode 10]

The communicating system, preferably as described in any one of Modes 2 to 9, wherein a representative value of the plurality of indices calculated is one of mean, median, and mode of frequency.

### [Mode 11]

The communicating system, preferably as described in any one of Modes 1 to 10, wherein the first line is a Multi-Protocol Label Switching (MPLS) line.

### [Mode 12]

A communicating method performed in a communicating system comprising:

a first gateway installed at a base containing a terminal(s), and is connected to at least a first line and a second line;
a second gateway connected to the first gateway through the first line;
a third gateway located in the same center as the second gateway and connected to a third line for connecting to the Internet; and
a controller controlling the first, the second, and the third gateways;
wherein the method comprises:
a step that calculates an index indicating a status of at least one of the first, the second, the third lines; and
a step that controls line switching at the first gateway based on the results of statistical processing on the calculated index.

### [Mode 13]

The communicating method, preferably as described in Mode 12, wherein the controller calculates a plurality of indices in a certain period of time, and controls the line switching at the first gateway based on the representative values of the plurality of calculated indices.

### [Mode 14]

The communicating method as described in Mode 12 or 13, wherein the line switching at the first gateway is controlled so that some of the packets sent from the terminal are forwarded from the second line when it is determined that the first line is tight.

### [Mode 15]

The communicating method, preferably as described in Mode 12 or 13, wherein the line switching at the first gateway is controlled so that some of the packets sent from the terminal are forwarded from the second line when it is determined that the third line is tight.

### [Mode 16]

A communicating method, preferably as described in any one of

Modes 12 to 15, wherein the line switching at the first gateway is controlled based on information described in a payload of the packets sent from the terminal to the Internet.

### [Mode 17]

The communicating method, preferably as described in Mode 16, wherein the line switching at the first gateway is controlled based on the type of application using the packets sent from the terminal to the Internet.

### [Mode 18]

The communicating method, preferably as described in any one of Modes 12 to 16, wherein calculation of the total amount of data transmitted from the terminal to the Internet through the second line is performed, and if it is expected that the total volume limitation of the second line will be applied and the communication speed will be suppressed based on the calculated total amount of data, a processing is performed to increase the upper limit of contractual allowable data in the second line.

### [Mode 19]

The communicating method, preferably as described in Mode 18, wherein the controller controls the first gateway so that packets forwarded from the first gateway over the second line are discarded at a predetermined rate when the total volume limitation of the second line is expected to be applied.

### [Mode 20]

The communicating method, preferably as described in Mode 19, wherein the first gateway is controlled so that packets used in applications that do not permit the use of the second line are discarded at the first gateway.

### [Mode 21]

The communicating method, preferably as described in any one of Modes 13 to 20, wherein the representative value of the plurality of indices calculated is one of mean, median, and mode of frequency.

### [Mode 22]

A program for causing a computer to execute processings set forth below; the computer comprising:

a first gateway installed at a base containing a terminal and connected to at least a first and second line,
a second gateway connected to the first gateway through the first line, and
a third gateway installed at a center containing the second gateway and connected to a third line to connect to the Internet,
and a controller to control each gateway;
wherein the processings comprise:
a process of calculating an index of a status of at least one of the first, second, and third lines, and
a process of controlling line switching at the first gateway based on the results of statistical processing on the calculated indices.
The program can be stored on a computer-readable storage medium. The storage medium can be non-transient, such as semiconductor memory, hard disk, magnetic recording medium, optical recording medium, and the like. The present invention can also be implemented as a computer program product. That is, Mode 22 can also be developed as follows.

### [Mode 23]

A computer-readable non-transient storage medium storing a program that causes a computer to execute processings set forth below;

the computer being installed in a controller that controls:

a first gateway installed at a base containing a terminal and connected to at least a first line and a second line,
a second gateway connected to the first gateway through the first line; and
a third gateway installed at a center containing the second gateway and connected to a third line to connect to the Internet;
wherein the program causes the computer to execute:
a process of calculating an index of the status of at least one of the first, second, and third lines, and
a process of controlling line switching at the first gateway based on the results of statistical processing on the calculated indices.
Note: Mode 22 and Mode 23 can be developed to Modes 2 to 11 likewise Mode 1.

It is to be noted that each of the disclosures in the abovementioned Patent Literatures etc. mentioned at Citation List is incorporated herein by reference. Modifications and adjustments of exemplary embodiments and examples are possible within the bounds of the entire disclosure (including the claims) of the present invention, and also based on fundamental technological concepts thereof. Furthermore, a wide variety of combinations and selections of various disclosed elements is possible within the scope of the claims of the present invention. That is, the present invention clearly includes every type of transformation and modification that a person skilled in the art can realize according to the entire disclosure including the claims and technological concepts thereof. In particular, with respect to the numerical ranges described in the present application, any numerical values or small ranges included in the ranges should be interpreted as being concretely described even if not otherwise explicitly recited.

### REFERENCE SIGNS LIST

10, 104 controller

11 CPU (Central Processing Unit)

12 memory

13 I/O interface

14 NIC (network interface card)

101 first gateway

102 second gateway

103 third gateway

201 communication controlling part

202 information input part

203 gateway controlling part

204 line status measuring part

205 line managing part

206, 302 storage part

301 packet processing part

What is claimed is:

1. A control apparatus in a mobile communication system including a terminal apparatus, the control apparatus comprising:
at least one processor; and
at least one memory coupled to the at least one processor, the at least one memory storing instructions that when executed by the at least one processor, cause the at least one processor to:
perform a first data communication with the terminal apparatus via a mobile access line using a mobile network and a non-mobile access line not using the mobile; network,
measure a round trip time of a session for the mobile access line and the non-mobile access line, respectively,
determine whether the mobile access line or the non-mobile access line is available based on the respective round trip time, and
perform a second data communication with the terminal apparatus using the access line selected by the determination.

2. The control apparatus according to claim 1, wherein
the round trip time is measured based on a Ping measurement.

3. A control method for a control apparatus in a mobile communication system including a terminal apparatus, the control method comprising:
performing a first data communication with the terminal apparatus via a mobile access line using a mobile network and a non-mobile access line not using the mobile network;
measuring a round trip time of a session for the mobile access line and the non-mobile access line, respectively;
determining whether the mobile access line or the non-mobile access line is available based on the respective round trip time; and
performing a second data communication with the terminal apparatus and the control apparatus using the access line selected by the determining.

4. The control method according to claim 3, wherein
the round trip time is measured based on a Ping measurement.

5. A terminal apparatus in a mobile communication system including a control apparatus, the terminal apparatus comprising:
at least one processor; and
at least one memory coupled to the at least one processor, the at least one memory storing instructions that when executed by the at least one processor, cause the at least one processor to:
performs perform a first data communication with the control apparatus via a mobile access line using a mobile network and a non-mobile access line not using the mobile network,
measure a round trip time of a session for the mobile access line and the non-mobile access line, respectively, and
perform a second data communication with the control apparatus via the mobile access line when the control apparatus determines that the mobile access line is determined as more useful than the non-mobile access line.

6. The terminal apparatus according to claim 5 wherein
the round trip time is measured based on a Ping measurement.

7. A communicating A communication method for a terminal apparatus in a communicating system including a control apparatus, the communication method comprising:
performing a first data communication with the control apparatus via a mobile access line using a mobile network and a non-mobile access line not using the mobile network;
measuring a round trip time of a session for the mobile access line and the non-mobile access line, respectively; and
performing a second data communication with the control apparatus via the mobile access line when the control apparatus determines that the mobile access line is more useful than the non-mobile access line.

8. The communication method according to claim 7, wherein
the round trip time is measured based on a Ping measurement.
